(19) United States
(12) Patent Application Publication
(10) Pub. No.: US 2026/0322886 A1
(43) Pub. Date: Oct. 15, 2026

(54) ENABLING PRIVATE CONNECTION TO CONTENT DELIVERY NETWORK (CDN)

(71) Applicant: Microsoft Technology Licensing, LLC, Redmond, WA (US)

(72) Inventors: Ashok Kumar NANDOORI, Frisco, TX (US); Abhishek K. TIWARI, Woodinville, WA (US); Varun CHAWLA, Sammamish, WA (US); Karthik UTHAMAN, Seattle, WA (US)

(21) Appl. No.: 19/180,125

(22) Filed: Apr. 15, 2025

(51) Int. Cl. H04L 67/141; H04L 12/46; H04L 61/4511

(52) U.S. Cl. CPC H04L 67/141; H04L 12/4666; H04L 61/4511

(57) ABSTRACT

The present disclosure relates to enabling a private connection to a Content Delivery Network (CDN). A data packet encapsulated with a tenant specific VNI is received by a driver, wherein the data packet comprising a user IP address in a source IP field and a subnet IP address in a destination IP field. The driver decapsulates the data packet to retrieve the tenant specific VNI and replaces the destination IP field with an internal IP address. The driver transmits the data packet to an edge server, wherein the data packet is processed by the edge server. The driver receives a returning data packet from the edge server comprising the internal IP address in the source IP field and the user IP address in the destination IP field. The driver replaces the source IP field with the subnet IP address and transmits the returning data packet to the edge router.

### BACKGROUND

Content Delivery Network (CDN) utilizes a fleet of edge servers to bring a variety of services and functionalities closer to users. CDN is designed to improve speed and efficiency of content delivery through content caching on the edge servers. A user on-premises can utilize the CDN functionalities by being connected to the nearest edge server through a public network such as the Internet. Although there are various protocols available to secure the communication between the on-premises user and the CDN, the conventional method involves accessing the CDN via a public endpoint. This approach, however, can inherently involve some potential security risks.

### SUMMARY

The disclosed examples are described in detail below with reference to the accompanying drawing figures listed below. The following Summary is provided to illustrate some examples in a simplified form that are further described in the Detailed Description. This Summary is not intended to identify key features or essential features of the claimed subject matter, nor meant to limit all examples to any particular configuration or sequence of operations.

An example method for providing a private content delivery network (CDN) connection comprises: receiving, by a driver, a data packet, from an edge router, the data packet encapsulated with a tenant specific Virtual Network Identifier (VNI), the data packet comprising a user IP address in a source IP field and a subnet IP address in a destination IP field; decapsulating, by the driver, the data packet to retrieve the tenant specific VNI; replacing, by the driver, the destination IP field of the data packet with an internal IP address; transmitting, by the driver, the data packet to an edge server, wherein the data packet is processed by the edge server; receiving, by the driver, a returning data packet from the edge server, the returning data packet comprising the internal IP address in the source IP field and the user IP address in the destination IP field; replacing, by the driver, the source IP field of the returning data packet with the subnet IP address; and transmitting, by the driver, the returning data packet to the edge router.

### BRIEF DESCRIPTION OF THE DRAWINGS

The disclosed examples are described in detail below with reference to the accompanying drawing figures listed below:

FIG. 1 illustrates a computing framework implementing private CDN connection in accordance with embodiments of the disclosed technology.

FIG. 2A-2C illustrates operation sequences of implementing private CDN connection that may be performed when using the example computing framework, such as the computing framework of FIG. 1.

FIG. 3 illustrates an example IP flow between components of computer framework, such as the computing framework of FIG. 1.

FIG. 4 illustrates a block diagram of an example edge server and an example driver that may be used in computing framework, such as the computing framework of FIG. 1.

FIG. 5A-5C illustrate flow charts of example operations that may be performed when using example computing framework, such as the computing framework of FIG. 1.

FIG. 6 illustrates a block diagram of an example computing device suitable for implementing some of the various examples disclosed herein.

Corresponding reference characters indicate corresponding parts throughout the drawings.

### DETAILED DESCRIPTION

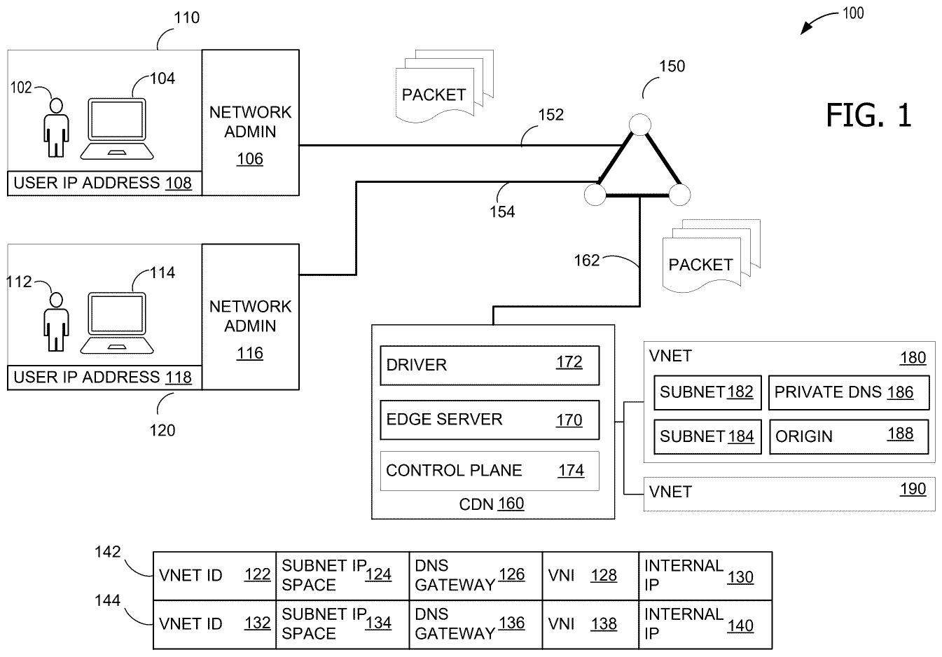

Certain embodiments of systems, devices, components, modules, routines, data structures, and processes providing for private connection to Content Delivery Network (CDN) are described below. In the following description, specific details of components are included to provide a thorough understanding of embodiments of the disclosed technology. A person skilled in the relevant art will also understand that the technology can have additional embodiments. The technology can also be practiced without several of the details of the embodiments described below with reference to FIGS. 1-6.

The various examples will be described in detail with reference to the accompanying drawings. Wherever possible, the same reference numbers will be used throughout the drawings to refer to the same or like parts. References made throughout this disclosure relating to specific examples and implementations are provided solely for illustrative purposes but, unless indicated to the contrary, are not meant to limit all examples.

A Content Delivery Network (CDN) generally refers to a network of interconnected servers, typically distributed geographically to provide content and services to users. Typically, a CDN includes geographically distributed edge servers, each having a cache of data such that users can access the data quickly and more efficiently. When a user requests content or service, CDN delivers it from the nearest edge server, reducing latency and improving load time. CDN supports multi-tenancy, allowing multiple tenants to share the same infrastructure. However, because multiple users can access CDN over the public internet, conventional CDNs face security and privacy issues.

The traditional method of accessing a CDN involves using a public network, such as the Internet. This approach can introduce some potential security risks. Since the connection is not private, there is a possibility that the data traffic could be intercepted as it traverses the public internet. This lack of dedicated connection can expose sensitive information to unauthorized parties, making the network vulnerable to various cyber threats. Conventional CDNs attempt to manage data traffic with stateful features, such as maintaining session information and tracking the details of ongoing connections, in order to ensure that packets belonging to the same session follow the same path through the network. However, the conventional method of stateful handling is insufficient for managing the return path due to multiple tenants utilizing overlapping private address spaces, which can generate identical connection tuples and lead to ambiguity in reverse traffic.

Aspects of the disclosure solve multiple problems that are necessarily rooted in computer technology and render use of computer network more reliable and better-performing, by providing the practical result of improved network-level security and traffic isolation. Several embodiments of the disclosed technology can enhance a level of network isolation and improve network security by providing private, dedicated connection to utilize the CDN functionalities. The embodiments of the disclosed technology can leverage the multi-tenancy of the CDN and provide scalable and efficient CDN performance while maintaining the entire connection private from the general public.

The embodiments of the disclosed technology provide tenant-specific private route that is dedicated solely to that tenant, thereby enhancing security at the network-level. The embodiments of the disclosed technology implement a direct, private route to an edge server of the CDN fleet that is not accessible by other users by using a user-specific identifier. For example, the embodiments of the disclosed technology utilize unique internal IP addresses that identify tenants to isolate data traffic for each tenant at the network level. By providing the network-level isolation of the data traffic, the sensitive data can remain hidden from the general public and interference from other tenants during routing is prevented. These advantageous results are accomplished, at least in part, by configuring a route dedicated to each tenant to direct traffic between the tenant and the CDN network. More specifically, the unique internal IP address within a designated range of private address space can be used to disambiguate which data path belongs to which tenant. This designated rage of private address space is designed to be reusable across different nodes, enabling clearer tenant separation. This approach ensures that the traffic to and from the edge server is isolated from other traffic. The embodiments of the disclosed technology enable maintaining multi-tenancy of CDN while keeping connection to each tenant completely isolated and private from other tenants by separating traffic at the network level.

Additionally, by integrating the CDN functionalities and the direct connectivity to a private VNET, the connection to the private VNET can leverage the benefits of the CDN, such as reduced latency of content delivery and enhanced efficiency of the resource allocation.

As used herein, a “packet” or “data packet” generally refers to a formatted unit of data carried by a packet-switched network. A packet typically includes user data along with control data. The control data can provide information for delivering the user data. Typically, the control data can be contained in headers and/or trailers of a packet. The control data can be often referred to as the packet header. For example, the control data can include source and destination network IP addresses/ports, protocol information (e.g., TCP, UDP), packet length, sequence number, acknowledgement number, hop counts, flags, options, and/or other suitable information regarding the user data. A data packet includes a source IP address field and a destination IP address field, typically within the control data or the packet header.

As used herein, a “cloud computing system” or a “cloud” generally refers to an interconnected computer network having a plurality of network devices that interconnect a plurality of servers or hosts to one another or to external networks. At least some of the servers or hosts can be located in different datacenters at diverse geographical locations. A cloud can be public when accessible to the general public, or can be private when only accessible to members of an organization.

As used herein, a VNET generally refers to a logically isolated virtual network environment within a cloud computing system. An organization or an entity can have a virtual network (VNET) hosted on a cloud computing system. A VNET can be used to manage resources such as Virtual Machines (VMs), databases, and applications within the cloud computing system. A VNET can be divided into subnets, each with its own range of IP addresses. Some subnets can be private and only accessible through a private endpoint.

As used herein, a tenant refers to any organization, company, enterprise, or entity that uses and interacts with the network's resources, shared infrastructure, or service. Each tenant operates within a logically isolated environment, ensuring that their data and applications remain secure and separate from those of other tenants. A tenant includes, but is not limited to, an individual, entity, company, organization, enterprise, agency, institution, etc.

As used herein, a user refers to any individual or device who can access a tenant's data, resources, applications, or services provided to that tenant. A user can be a part of the organization, company, or entity that constitutes the tenant. A user can include, but is not limited to, an employee, a contractor, a student, a customer, or any other individual associated with the tenant. Users may be subject to specific permissions rules that define what resources and services they can access within the tenant's environment. These permissions and rules can be set by a network administrator of the tenant.

FIG. 1 is a schematic diagram illustrating a computing framework 100 implementing private connection to CDN in accordance with embodiments of the disclosure. As illustrated in FIG. 1, a tenant 110 has a VNET 180 hosted in a cloud computing system. The VNET 180 is a virtual, isolated portion of the cloud computing system where a tenant (e.g., tenant 110) can deploy and manage resources, such as virtual machines, applications, websites, and other services. VNET isolation ensures that resources within the VNET are separated from other networks, enhancing security for the user. The tenant 110 deploys its internal resources in the VNET 180. In some embodiments, the tenant 110 deploys internal web applications on virtual machines (VMs) or container instances within the VNET 180.

The VNET 180 can be divided into multiple subnets to further segment the VNET 180. For example, the VNET 180 includes a private subnet 182 and a private subnet 184 for different types of resources, including, but not limited to, web servers, databases, and application servers. Even though only two private subnets, private subnet 182 and private subnet 184 are shown in FIG. 1, the VNET 180 can include any number of private subnets. The VNET 180 can also include a private DNS server 186, and the origin server 188.

The resources within the VNET 180 are assigned private IP addresses within the VNET, selected from the subnet IP space 124. The tenant 110 sets up a private DNS zone within the VNET 180. The private DNS zone includes records that map the DNS name to the private IP addresses of the web application servers. The private DNS server 186 within the VNET 180 is configured to look up the private IP address of the web application servers based on the DNS name.

The computing framework 100 can support multi-tenant architecture, where multiple tenants share the same physical infrastructure but have logically isolated environments. Each tenant's data and applications are kept separate and secure from each other, ensuring privacy and security. As shown in FIG. 1, the tenant 110 and tenant 120 are separate entities, departments, business units, companies, enterprises, or organizations. The tenant 110 deploys resources in the VNET 180, and the tenant 120 deploys resources in the VNET 190. The VNET 180 and the VNET 190 are logically isolated, such that the tenant 110 can only access the VNET 180 and the tenant 120 can only access the VNET 190. Users (e.g., user 102 using the user device 104) of the tenant 110 can access the resources in the VNET 180, and users (e.g., user 112 using the user device 114) of the tenant 120 can access the resources in the VNET 190.

The operations of the computing framework 100 are primarily described for the tenant 110, but similar operations can also be applied for the tenant 120. Although FIG. 1 shows two tenants, tenant 110 and tenant 120, this is merely for illustrative purposes, and not intended to be used to limit the scope of the disclosure. The computing framework 100 can accommodate any suitable number of tenants. The operations of the computing framework 100 as described herein can be performed for multiple tenants simultaneously and/or in parallel.

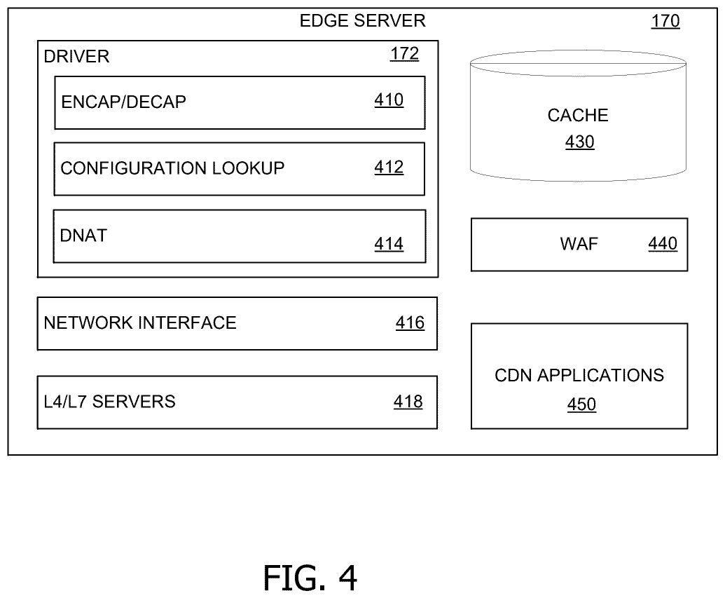

As shown in FIG. 1, the CDN 160 includes an edge server 170, a driver 172, and a control plane 174. Although FIG. 1 only shows one edge server, edge server 170, the CDN 160 includes a fleet of edge servers, and the nearest edge server 170 is selected based on the geographical location of the connection request. The CDN 160 can connect to the one or more origin servers 188, which are hosted in the VNET 180. The CDN 160 can also connect to the VNET 190. The edge server 170 in the CDN caches the resources in the VNET 180 and the VNET 190, such that the resources can be provided faster and more efficiently, while isolating the resources from the VNET 180 and the VNET 190 such that only the tenant 110 can access the cached resources from the VNET 180 and only the tenant 120 can access the cached resources from the VNET 190. The edge server 170 can perform other CDN functionalities as described in reference to FIG. 4.

As shown in FIG. 1, the user 102 accesses the resources in the VNET 180 through the edge router 150 and the CDN 160 using the user device 104. The user device 104 can include a desktop computer, laptop computer, tablet computer, smartphone, or other suitable computing devices. As shown in FIG. 1, the user device 104 is assigned the user IP address 108 to connect to the Internet. As shown in FIG. 1, the user 112 accesses the VNET 190 through the edge router 150 and the CDN 160 using the user device 114. The user device 114 is assigned the user IP address 118 to connect to the Internet.

As illustrated in FIG. 1, the computing framework 100 includes the user device 104 within the tenant network of the tenant 110 accessing the CDN 160 via the edge router 150. The edge router 150 can include any suitable router that provides direct connectivity between a user on-premises (e.g., user device 104) to a VNET (e.g., VNET 180), such as Microsoft ExpressRoute™, AWS Direct Connect™, Google CLOUD INTERCONNECT™, etc. Even though only one user 102 with one user device 104 on the on-premises network of the tenant 110 is shown in FIG. 1 for illustration purposes, in other embodiments, multiple users with multiple user devices can be connected to the same CDN 160 through the edge router 150.

A provisioning process begins when the user device 104 sends a request for a private connection to the CDN 160. The network administrator 106 of the tenant 110 starts the provisioning process by requesting connectivity to the edge router 150. The network administrator 106 specifies a VNET ID 122 and a subnet IP space 124.

Similarly, a provisioning process for the user device 114 begins when the user device 114 requests a private connection to the CDN 160. The network administrator 116 of tenant 120 specifies a VNET ID 132 and a subnet IP space 134.

A private profile 142 for the tenant 110 is generated by the control plane 174 of the CDN 160 after receiving the connectivity request from the network administrator 106. The private profile 142 is designed to enhance the security and efficiency of interactions with the CDN 160 by facilitating a private connection. The private profile 142 stores the parameters to create the private connection to the CDN 160. The control plane 174 pushes the configurations of the private profile 142 to the edge server 170 and the driver 172. The control plane 174 also generates a private profile 144 for the tenant 120 after receiving the connectivity request from the network administrator 116.

After generating the private profile 142, the control plane 174 connects with the edge router 150. The edge router 150 adds a route, which directs data traffic to the edge server 170 from the edge router 150. In some embodiments, the edge router 150 adds the route using Border Gateway Protocol (BGP) and sets an Anycast IP address of the edge server 170 as the next hop. The Anycast IP address allows for using one IP address for multiple endpoints, enabling the nearest edge server 170 to be selected based on the location of the connectivity request. Anycast refers to a networking technique using a single IP address for multiple devices or multiple endpoints, for example.

The private profile 142 includes the VNET ID 122. Each VNET (e.g., VNET 180) has a unique VNET identifier (ID). The VNET ID generally refers to an identifier that can be used to identify a virtual network within a cloud computing system. For example, as shown in FIG. 1, the VNET 180 has the VNET ID 122 as its unique ID. The network administrator 106 of the tenant 110 specifies the VNET ID 122 when the private connection is requested.

The network administrator 106 of the tenant 110 also specifies the subnet IP space 124 when the private connection is requested. The private subnet 182 uses IP addresses in a designated IP space, which is specified in the subnet IP space 124. The subnet IP space 124 includes a range of IP addresses dedicated to the private subnet 182 and not routable on the public internet. In some embodiments, a/28 private IP space is used. A/28 private IP space refers to a subnet with a Classless Inter-Domain Routing (CIDR), which allows 16 IP addresses. For example, if the subnet IP space 124 is 10.11.11.0/28, the subnet IP addresses would range from 10.11.11.0 to 10.11.11.15. Using the VNET ID 122 and the subnet IP space 124 ensures that the traffic remains within the private network boundaries, enhancing security.

The private profile 142 also includes the DNS gateway 126. The DNS gateway 126 can be provided with the connection request, or automatically discovered based on the VNET ID 122 and the subnet IP space 124. In some embodiments, based on the provided VNET ID 122 and the subnet IP space 124, the IP address of the DNS gateway 126 in the VNET 180 is automatically identified by the control plane 174 or any other suitable component of the CDN 160. In some other embodiments, the IP address of the DNS gateway 126 is provided in the request. The DNS gateway 126 is used to resolve origin DNS name, such that the resources in the origin server (e.g., origin server 188) can be accessed.

The private profile 142 includes a Virtual Network Identifier (VNI) 128. A VNI refers to a value that identifies a specific virtual network in the data plane and can be used to maintain tenant traffic isolation. As the VNI 128 is unique to the tenant 110, the VNI 128 is used to identify the tenant 110 in the data plane. Each tenant in the computing framework 100 receives a distinct non-routable IP address (e.g., unique internal IP address 130) mapped to its VNI. In some embodiments, the VNI 128 is unique for the VNET 180 and/or the private subnet 182 and the VNI 128 can be automatically deduced based on the VNET ID 122. The VNI 128 is generated during the provisioning process. In some embodiments, the VNI 128 is generated by the control plane 174.

The private profile 142 includes a unique internal IP address 130. Each user device (e.g., user device 104) is assigned a unique internal IP address 130. The unique internal IP address 130 is a non-routable IP address, generated by the control plane 174 or any other suitable component of the CDN 160. The unique internal IP address 130 can be generated based on the VNET ID 122, the subnet IP space 124, and/or the VNI 128. In some embodiments, the unique internal IP address 130 is selected from a pool of available addresses based on the VNET ID 122, the subnet IP space 124, and/or the VNI 128. However, any other suitable methods can be used to generate the unique internal IP address 130. The unique internal IP address 130 can be Internet Protocol version 4 (IPv4) address, fd01:: (unique local address) prefix for Internet Protocol version 6 (IPv6) address, or in any other suitable format. The unique internal IP address 130 is used to identify the tenant 110 in the data plane. In some embodiments, the internal IP address 130 is hidden and only accessible by the edge server 170, the driver 172, and the control plane 174. In some embodiments, multiple unique IP addresses can be used instead of one unique IP address. The unique internal IP address 130 can be re-used for the tenant 110 for future requests. In some embodiments, the tenant 110 can use the same internal IP address 130 for multiple endpoints. In other embodiments, a new internal IP address is generated and assigned to the tenant 110 for each private connection request.

The edge server 170 uses this unique internal IP address 130 to separate the traffic for the user device 104 from other traffic. The unique internal IP address 130 acts as an identifier for the edge server 170 to recognize the tenant 110. As described below, the edge server 170 uses the unique internal IP address 130 while connecting to the origin server 188 of the tenant 110.

The VNET ID 122, subnet IP space 124, DNS gateway 126, VNI 128, and the internal IP address 130 are stored and persist in the private profile 142 of the tenant 110. For tenant 120, the VNET ID 132, subnet IP space 134, DNS gateway 136, VNI 138, and the internal IP address 140 are stored and persist in the private profile 144. In some embodiments, the private profile 142 and the private profile 144 are stored in the control plane 174.

The private connection request from the network administrator 106 specifies the VNET 180 and the private subnet 182 by the VNET ID 122 and subnet IP space 124. The private connection request creates a private endpoint on the user device 104 to the private subnet 182 as specified in the request. The private endpoint is dedicated to the user device 104 and accessible only by the users of the tenant 110.

As shown in FIG. 1, an edge router 150 routes the traffic from the user device 104 to the CDN 160. During the provisioning process, based on the authorization scope of the tenant 110, appropriate Application Programming Interfaces (API) of the edge router 150 are called to configure the edge router 150. As described below, the edge router 150 and the driver 172 enables the user device 104 to connect to the CDN 160 over a private network connection.

A Multiprotocol Label Switching (MPLS) tunnel 152 is used to transmit data packets between the user device 104 and the edge router 150. The MPLS tunnel 152 directs data packets from the user device 104 to the edge router 150. The MPLS tunnel 152 enables directing data packets along predetermined, direct paths. The MPLS tunnel 152 creates an isolated private path for the data packets, ensuring that the traffic is kept separate from other users' traffic. Additionally, the MPLS tunnel 152 uses predetermined paths for transmitting the data packets, which can be dedicated to the user device 104. The MPLS tunnel 152 enhances security because it operates as a private network, inaccessible from the public internet. The user device 114 of the tenant 120 uses a MPLS tunnel 154 to transmit data packets between the user device 114 and the edge router 150.

The edge router 150 is configured to route data packets from the user device 104 to the edge server 170. When the edge router 150 recognizes that the destination IP address is the private subnet IP address, the edge router 150 establishes a tunnel 162 to the edge server 170. In some embodiments, the tunnel 162 is a Virtual Extensible Lan (VxLan) tunnel. In some other embodiments, a Generic Routing Encapsulation (GRE) tunnel or a Network Virtualization using GRE (NVGRE) tunnel can be used as the tunnel 162. In other embodiments, a suitable Virtual Private Network tunnel can be used as the tunnel 162.

When the request for private connection to the private subnet 182 is received, a private subnet IP address is assigned for the private endpoint in the private subnet 182. In some embodiments, multiple private IP addresses within the subnet IP space 124 can be used, instead of one.

The edge router 150 identifies that the data packets need to be forwarded to the private subnet 182 based on the destination IP address being the private subnet IP address. After establishing the tunnel 162, the edge router 150 encapsulates the data packets and adds an outer header to the data packets. The VNI 128 is included in the outer header to identify that the user device 104 belongs to the tenant 110. In some embodiments, when the tunnel 162 is a VxLan tunnel, the edge router 150 performs a VxLan encapsulation to encapsulate the data packets. In some other embodiments, which include GRE tunnels, the edge router 150 performs GRE encapsulation of the data packets. In other embodiments, other suitable encapsulation methods are used. The next hop for the data packets is set as the edge server 170. In some embodiments, Anycast IP address for the edge server 170 can be set as the next hop. The encapsulated data packets are forwarded to the edge server 170.

For data packets from the user device 114, the edge router 150 encapsulates the data packets to include the VNI 138 in the outer header to identify that the user device 114 belongs to the tenant 120. The edge router 150 forwards the encapsulated data packets to the edge server 170.

The edge server 170 is connected to a driver 172, which is configured to encapsulate and decapsulate data packets, look up configurations, and modify IP addresses of the data packets. The driver 172 can be an extended Berkley Packet Filter (eBPF), L2 driver, or any other suitable driver configured to perform encapsulation/decapsulation of data packets. In some embodiments, the driver 172 is included in the edge server 170. In other embodiments, the driver 172 is an in-line router. In some other embodiments, the driver 172 is a separate driver located on a separate node from the edge server 170. In some other embodiments, the driver 172 is a dedicated, separate router or a man-in-the-middle configured to perform functions described below. The driver 172 is described in more detail in reference to FIG. 4.

After receiving data packets from the edge router 150, the driver 172 decapsulates the data packets from the user device 104 to retrieve the VNI 128. Using the VNI 128, the driver 172 identifies the unique internal IP address 130 from the private profile 142 by performing a configuration lookup. In some embodiments, the private profile 142 is pushed to the driver 172 from the control plane 174. The driver 172 modifies the destination IP in the header of the data packets. For example, the destination IP in the header before the decapsulation is the private IP of the private subnet 182. The edge server 170 rewrites the destination IP address and replaces it with the unique internal IP address 130. After the decapsulation and rewriting of the IP address, the data packets are sent to the edge server 170 for CDN applications.

In some embodiments, instead of rewriting the destination IP address, the unique internal IP address 130 is added to the IP option or the TCP option in the option field of the header. The tenant information including the unique internal IP address 130 can be embedded in the option field, and the tenant information can be retrieved from the header and used to isolate the tenant traffic by the edge server 170.

For tenant traffic from the tenant 120, the driver 172 decapsulates the data packets from the user device 114 and retrieves the VNI 138. The driver 172 identifies the unique internal IP address 140 for the tenant 120 from the private profile 144. The edge server 170 rewrites the destination address and replaces it with the unique internal IP address 140.

The edge server 170 can identify that the data packets originated from the tenant 110 based on the unique internal IP address 130. Similarly, the edge server 170 can identify that the data packets originated from the tenant 120 based on the unique internal IP address 140. When the edge server 170 receives the data packets from the user device 104 and the user device 114, the edge server 170 can restrict the access to the CDN resources that belong to the tenant 110 such that only the user device 104 can access the CDN resources. The user device 114 cannot access the CDN resources that belong to the tenant 110 because the unique internal IP address 130 is different from the unique internal IP address 140. By the driver 172 adding string isolation, the edge server 170 ensures that a tenant can only access its own resources. By using the unique internal IP addresses, the edge server 170 ensures that the returning packets are not returning to a wrong tenant, thereby maintaining strict network isolation. This prevents any cross-tenant data exposure, ensuring that each tenant operates in a secure and isolated environment. The components and functionalities of the driver 172 and the edge server 170 are described in more detail with reference to FIG. 4.

If the resource requested by the user device 104 is in the cache of the edge server 170, the edge server 170 responds back with data packets. The source IP address in the header of the data packets returning from the edge server 170 to the user device 104 is the unique internal IP address 130 and the destination IP address is the user IP address 108. The edge server 170 sends the returning data packets to the driver 172. For the data packets returning from the edge server 170 to the user device 104, the source IP address is the unique internal IP address 140. By using the unique internal IP addresses 130 and 140, the data packets are isolated in the edge server 170, and the resources in the CDN 160 that belong to each tenant are restricted only for the respective tenant.

On the return path, the driver 172 identifies the tenant information based on the source IP address. In some embodiments, the driver 172 examines the source IP address and port information. The driver 172 modifies the source IP address of the returning packets, replacing it with the private subnet IP address for the tenant 110. The driver 172 encapsulates the returning packets to add the VNI 128 and forwards the data packets to the edge router 150, setting the edge router 150 as the next hop. The driver 172 adds the tunnel 162, sets the source as the edge server 170 and the next hop as the edge router 150, and sends the returning data packets to the edge router 150. In some embodiments, the tunnel 162 is a VxLan tunnel. The edge router 150 receives the returning data packets via tunnel 162 and forwards them to the user device 104.

If the cache in the edge server 170 cannot process the data packets, or the cache in the edge server 170 does not have the requested content, the edge server 170 forwards the data packets to the origin server 188 and retrieves the requested content from the origin server 188. In some embodiments, the origin server 188 is accessible by its domain name. However, the domain name needs to be resolved to an IP address to be accessed by the edge server 170. The DNS records that map the domain name to the private IP address are set up to ensure name connectivity. Because the endpoint to the origin server 188 is a private endpoint, the origin domain name needs to be resolved by the private DNS server 186 to an IP address within the tenant's subnet that has a route to the edge server 170. Additionally, because the private DNS server 186 cannot be accessed through a public network, the request is routed through the edge router 150 to reach the private DNS server 186.

When the edge server 170 identifies that the DNS name is private, the edge server 170 sends the DNS request, which binds the unique internal IP address 130 as the source IP address and the DNS gateway 126 as the destination IP address. The driver 172 receives the request from the edge server 170. The driver 172 recognizes that the source IP address of the DNS request is non-routable, and the driver 172 identifies the tenant 110 from the unique internal IP address 130 and encapsulates the DNS request with the VNI 128. The driver 172 sets the next hop as the edge router 150, adds the tunnel 162 (e.g., VxLan tunnel), and sends the request to the edge router 150.

The edge router 150 receives the DNS request and routes the DNS request to the private DNS server 186 in the VNET 180 as the destination IP address is set to the DNS gateway 126. The private DNS server 186 receives the request from the edge router 150 and resolves the origin server's domain to an origin IP address.

In some embodiments, a CNAME record or CNAME chain is set up for the domain name. A CNAME record refers to a type of DNS record that maps one domain name to another. If the domain name that the user 102 uses is a front-end CNAME, the private DNS server 186 follows the CNAME chain until it reaches the final domain name with an A record, which contains the private IP address. The private DNS server 186 retrieves the private IP address and returns it to the edge router 150. The resolved origin IP address is sent to the edge server 170. The edge server 170 uses the resolved origin IP to retrieve the requested content. The edge server 170 sends an HTTP request by binding the unique internal IP address as the source IP address to the origin IP address. The edge server 170 sends the HTTP request to the driver 172, and the driver 172 encapsulates the HTTP request before sending it to the edge router 150 for routing.

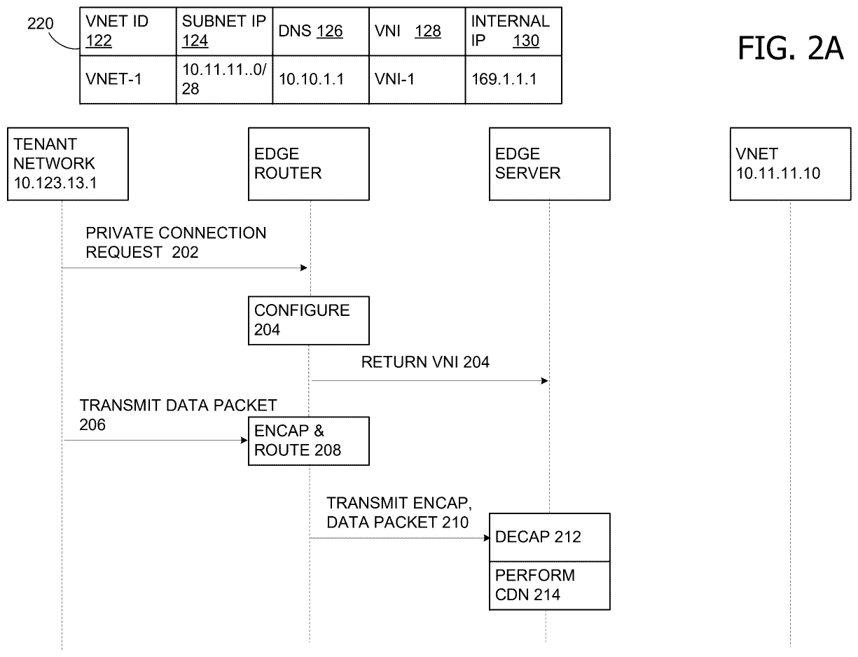

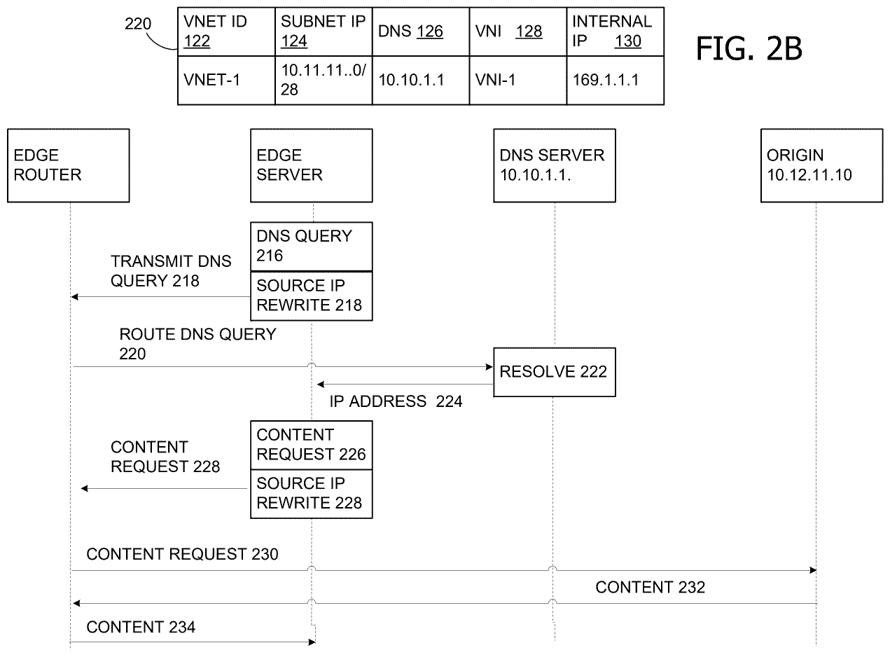

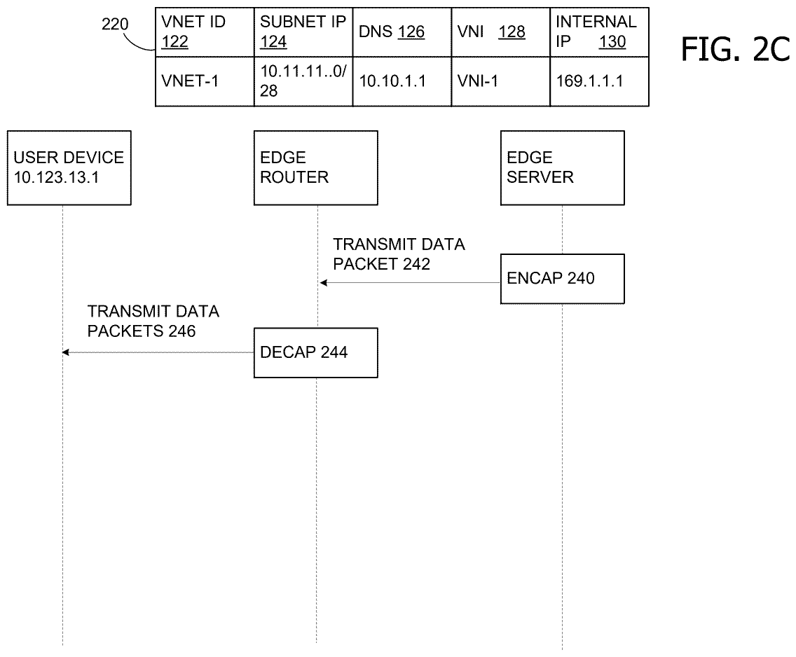

FIG. 2A-2C is a sequence diagram of an example scenario of providing a private CDN connection between the user device 104 and the VNET 180 performed by the computing framework 100. FIG. 2A illustrates providing a private connection from the user device 104 to the CDN 160. As shown in FIG. 1, the user device 104 is a device on the network of the tenant 110, which uses the user IP address 108. For illustration only, the user IP address is 10.123.13.1 as shown in FIG. 2A. As shown in FIG. 2A, the private profile 142 illustrates an example configuration used for the computing framework 100. For illustration only, the VNET ID 122 is VNET-1, the subnet IP space 124 is 10.11.11.0/28, the DNS gateway 126 is 10.10.1.1, the VNI 128 is VNI-1, and the unique internal IP address 130 is 169.1.1.1. The private subnet IP address selected for this example is 10.11.11.10, which is one of the IP addresses within the subnet IP space 124. These configuration parameters and IP addresses are provided as examples only and not intended to be used to limit the scope of the disclosure.

The user device 104 sends a private connection request at 202. The network administrator of the tenant 110 (e.g., network administrator 106) configures the VNET ID 122 and the subnet IP space 124 as VNET-1 and 10.11.11. 0/28 respectively. The VNET ID 122 and the subnet IP space 124 are provided to the edge router 150 at 202. Optionally, the DNS gateway 126 can also be provided by the network administrator. Alternatively, the control plane of the CDN (e.g., control plane 174) can identify the DNS gateway 126 based on the VNET ID 122 and the subnet IP space 124. At 204, the edge router 150 configures the edge router 150 using APIs within the appropriate authorization scope of the tenant 110. The edge router 150 adds IP addresses in the subnet IP space 124 to its internal routing table such that the private subnet 182 can be used privately by the edge server 170. In some embodiments, an internal BGP (iBGP) route is used to add the subnet IP space 124. The next hop, which is the next destination to which the data packets are forwarded, is set as the edge server 170. In some embodiments, Anycast IP address for the edge server 170 is used to route the traffic to the nearest edge server 170. The configuration of the edge router 150 includes the edge router 150 returning the VNI 128, VNI-1 to the control plane 174. The VNI 128 persists in the private profile 142.

At 206, a data packet originates from the user device 104 reaches the edge router 150 via MPLS tunnel (e.g., MPLS tunnel 152). In this example, the data packet has <10.123.13.1, 10.11.11.10> as the source IP address and the destination IP address, for the data packet is originated from the user device 104 and destined to the private subnet 182. At 208, the edge router 150 checks the routing table, which includes information about the next hop for different destination IP addresses, for the entry for the private subnet IP address, 10.11.11.10. The edge router 150 identifies the edge server 170 as the next hop, because the next hop for IP addresses in the subnet IP space 124 is set as the edge server 170. The edge router 150 encapsulates the data packet, adding the VNI 128 to the data packet's outer header. The edge router 150 adds a tunnel (e.g., tunnel 162) to the edge server 170 and forwards the data packet to the edge server 170. In some embodiments, the tunnel to the edge server is a VxLan tunnel, and the next hop is set as <VxLan/Edge Server VIP>.

At 210, the encapsulated packet is forwarded to the edge server 170 and the edge server 170 sends the encapsulated packet to the driver 172. At 212, the driver 172 receives and decapsulates the encapsulated data packet. As described above in reference to FIG. 1, the driver 172 is connected to the edge server 170. In some embodiments, the driver 172 is a separate driver or router dedicated to the edge server 170. In some other embodiments, the driver 172 is an In-node processor. In some embodiments, the driver 172 is an eBPF driver. The driver 172 decapsulates the data packet and retrieves the VNI 128 at 212.

The driver 172 looks up the unique internal IP address 130 from the VNI 128 from the private profile 142. In this example, the driver 172 identifies the unique internal IP address 130 as 169.1.1.1 using the retrieved VNI 128, VNI-1, from the private profile 142. The driver 172 rewrites (e.g., stateful rewriting) the destination IP address of the data packet, replacing it with the unique internal IP address 130. The source IP address and the destination IP address of the data packet after rewriting is <10.123.13.1, 169.1.1.1.> respectively.

After rewriting the destination IP address, the data packet is sent to the edge server 170. The edge server 170 performs CDN functions. The CDN functions provided by the edge server 170 can be various, such as caching, WAF, and routing. In some embodiments, the resources in the private subnet 182 can be cached in the edge server and provided to the user device 104 through the edge router 150.

FIG. 2B illustrates the operations of the components of the computing framework 100, providing a private connection to the VNET 180 using the edge router 150 and the edge server 170. In particular, FIG. 2B illustrates processing the request from the user 102 when the edge server 170 cannot process the requested data or the requested content is not available in the cache of the edge server 170. FIG. 2B also illustrates resolving a domain name by a private DNS resolver in the VNET 180, using the private connection through the edge server 170 and the edge router 150.

In case of a cache miss, the edge server 170 connects to the origin server and retrieves the requested content from the origin server. In this example, the origin server is accessible by its domain name. Accordingly, the domain name needs to be resolved to an IP address to access the origin server. As discussed above, the origin domain name needs to be resolved by the private DNS server (e.g., private DNS server 186) in the private subnet 182 in order to keep the connection private and hidden from the public. The private DNS server cannot be accessed through a public network; therefore, the DNS request is routed through the edge router 150 to be resolved.

At 216, the edge server 170 generates a DNS query request that will be sent to the edge router 150. In the header of the request, the edge server 170 binds the unique internal IP address 130 as the source IP address, and the destination IP address is the DNS gateway 126, such that the request has the source and the destination as <169.1.1.1., 10.10.1.1.>. At 218, the driver 172 processes the DNS query request received from the edge server 170. The driver 172 identifies the unique internal IP address 130 and replaces the source IP address with the private subnet IP address, setting the source IP address and the destination IP address as <10.11.11.10, 10.10.1.1.>. The driver 172 sets the next hop as the edge router 150, adds a tunnel (e.g., tunnel 162), and sends the request to the edge router 150. In some embodiments, the tunnel 162 is a VxLan tunnel.

At 220, the edge router 150 routes the DNS query request to the private DNS server in the VNET 180 as the destination IP address is set to the DNS gateway 126. At 222, the private DNS server receives the request from the edge router 150 and resolves the origin server's domain name to the IP address of the origin server. In this example, the domain name can be “www.example.com.” In some embodiments, the domain name has a Canonical Name (CNAME) chain. In this example, the user 102 uses “www.example.com,” which the front-end CNAME for the private subnet 182. Table 1 shows an exemplary CNAME chain for the private subnet 182 and the origin server.

TABLE 1
CNAME Chain

| | DNS Name | A |
|---|---|---|
| Subnet 182 | www.example.com | xyz.example.net |
| | xyz.example.net | 10.11.11.10 |
| Origin server | origin.server.com | 10.12.11.10 |

The private DNS server traces the CNAME chain and finds the IP address. In this example, www.example.com points to xyz.example.net, which resolves to the IP address 10.11.11.10. Similarly, the private DNS server resolves origin.server.com to 10.12.11.10. At 224, the resolved origin IP address is return to the edge router 150, with the source IP address and destination IP address <10.10.1.1., 10.11.11.10>. Based on the destination IP address, the edge router 150 routes the resolved origin IP address to the edge server 170 at 226. At 228, the driver 172 replaces the destination IP address with the unique internal IP address 130, and the edge server 170 receives the resolved origin IP address with the source IP address and the destination IP address <10.10.1.1., 169.1.1.1>. Because the driver 172 rewrites the destination IP address and replaces it with the unique internal IP address 130, the edge server 170 can associate the origin IP address with the tenant 110 based on the unique internal IP address 130 in the destination IP address field.

The edge server 170 uses the resolved origin IP to retrieve the requested content. After the edge server 170 has the IP address associated with the domain name, the edge server 170 creates a content request at 230. In some embodiments, the content request is an HTTP request. In this example, the content request generated by the edge server 170 has the unique internal IP address as the source IP address and the origin IP address as the destination IP address, <169.1.1.1., 10.12.11.10>. At 232, the driver 172 rewrites the source IP address, replacing it with the subnet IP address, <10.11.11.10, 10.12.11.10>, and sends it to the edge router 150. At 234, the edge router 150 forwards the content request to the origin server. The origin server returns the requested content to the edge router 150 at 236. The content transmitted from the origin server has the source IP address and the destination IP address <10.12.11.10, 10.11.11.10>. At 238, the edge router 150 examines the destination IP address, 10.11.11.10, and identifies that the content needs to be routed to the edge server 170. The edge router 150 forwards the content to the driver 172, which rewrites the destination IP address and replaces it with <10.12.11.10, 169.1.1.1>, such that the edge server 170 recognizes that the content is for the tenant 110 from its unique internal IP address 130.

FIG. 2C illustrates a series of sequences of returning data packet (e.g., content) from the edge server 170 to the user device 104. At 240, the edge server 170 prepares the return packet with the source IP address and the destination IP address, <169.1.1.1., 10.123.13.1>. At 242, the driver 172 receives the return packet and encapsulates the data packet, adding the VNI. The driver 172 replaces the source IP address with the subnet IP address, <10.11.11.10, 10.123.13.1>. At 244, the driver 172 forwards the data packet to the edge router 150. At 246, the edge router 150 decapsulates the return packet and retrieves the VNI 128, which identifies the tenant 110. The edge router 150 forwards the return packet to the user device 104 at 248.

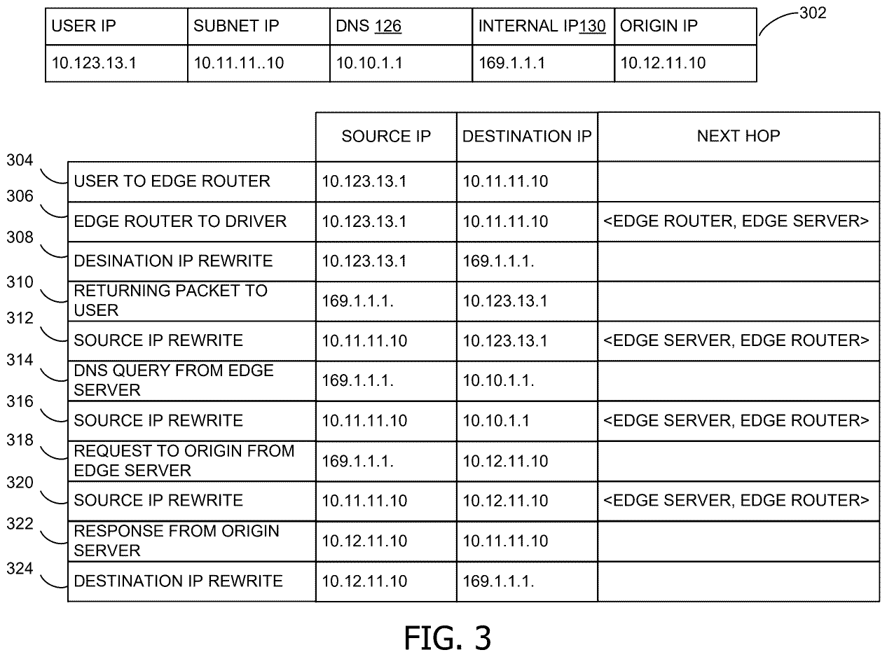

FIG. 3 shows examples IP flow (e.g., source IP address and the destination IP address) for the paths connecting the user device 104, the edge router 150, the edge server 170, the private DNS server 186, and the origin server 188 during the operations described in FIG. 2A-2C.

302 is a table of IP addresses used to illustrate the operations described in FIG. 2A-2C.

304 shows the IP flow from the user device 104 to the edge router 150. The source IP address field has the user IP address, 10.123.13.1, and the destination IP address field has the IP address of the private subnet 182.

306 shows the IP flow from the edge router 150 to the driver 172 for data in the edge server 170. The edge router 150 encapsulates the data packet to add VNI (e.g., VNI 128), and sets the next hop as the edge server.

308 shows the IP rewriting done by the driver 172. The driver 172 changes the destination IP address to the unique internal IP address 130, 169.1.1.1 in this example. The destination IP address rewriting is done when the driver 172 sends the data packet to the edge server 170, such that the edge server 170 can associate the data packet with the tenant 110.

310 shows IP flow for the return packet from the edge server 170. The source IP address is 169.1.1.1, and the destination IP address is the user IP address, 10.123.13.1.

312 shows the IP rewriting done by the driver 172 for the data packet returning to the user device 104. The driver 172 rewrites the source IP address field, changing it from 169.1.1.1. to 10.11.11.10. The driver 172 encapsulates the data packet, setting the edge router 150 as the next hop. The driver rewrites the source IP address field for the data packets received from the edge server 170, because the edge server 170 sets the source IP address as the unique internal IP address 130 for all returning packets to the tenant 110. As the unique internal IP address 130 is only internally used within the CDN 160, the driver 172 replaces the unique internal IP address 130 with the private subnet IP address and forwards the data packets to the edge router 150.

314 shows the IP flow of the DNS query from the edge server 170. The source IP address is 169.1.1.1, and the destination IP address is the DNS gateway 126, 10.10.1.1, in this example.

316 shows the driver 172 rewriting the source IP address, changing it from 169.1.1.1. to 10.11.11.10. The driver 172 encapsulates the data packet, setting the edge router 150 as the next hop.

318 shows the IP flow of the content request from the edge server 170 to the origin server. The source IP address is 169.1.1.1., and the destination IP address is the IP address of the origin server, 10.12.11.10. The content request reaches the driver 172.

320 shows the driver 172 rewriting the source IP address from 169.1.1.1. to 10.11.11.10. The driver 172 sets the edge router 150 as the next hop.

322 shows the IP flow of the response from the origin server. The source IP address is the IP address of the origin server, 10.12.11.10. The destination IP address is 10.11.11.10. The response reaches the edge router 150. Based on the destination IP address, the edge router 150 recognizes that the response needs to be forwarded to the edge server 170.

324 shows the driver 172 rewriting the destination IP address when the driver 172 receives the response from the edge router 150. The destination IP address is replaced the destination IP address with the unique IP address 130, 169.1.1.1. The response is forwarded to the edge server 170.

FIG. 4 is a block diagram illustrating components of an edge server (e.g., edge server 170) and a driver (e.g., driver 172). By way of example and not limitation, the driver 172 can be placed within the edge server 170 as shown in FIG. 4. However, the driver 172 is not limited to being placed within the edge server 170. As described above, in some embodiments, the driver 172 can be a separate, dedicated router. In some embodiments, the driver 172 is placed in-line as the edge server 170. In some other embodiments, the driver 172 is not in-line but on a different node than the edge server 170.

The driver 172 includes encap/decap component 410. The encap/decap component 410 encapsulates and decapsulates data packets forwarded to the edge server 170 before the data packets reach the edge server 170. For example, as described above in reference to FIG. 1-3, the encap/decap component 410 decapsulates the data packets from the edge router 150 to retrieve the VNI (e.g., VNI 128) of the user (e.g., user 102). The encap/decap component 410 encapsulates data packets being forwarded to the edge router 150 and sets the edge router 150 as the next hop.

The driver 172 includes a configuration lookup component 412. After retrieving the VNI (e.g., VNI 128), the configuration lookup component 412 looks up the configuration table of tenant profiles and identifies the unique internal IP address (e.g., unique internal IP address 130), which identifies the user device for routing.

The driver 172 includes Designated Network Address Translation (DNAT) component 414. After identifying the unique internal IP address 130, the DNAT component 414 modifies the source IP address or the destination IP address of data packets. The DNAT component 414 replaces the source IP address or the destination IP address with the unique internal IP address, such that the edge server 170 isolates the data packet with the unique internal IP address from the other traffic. As described above with reference to FIG. 1-3, the DNAT component 414 converts the IP address of the data packet depending on where the packet is being forwarded to. For example, the DNAT component 414 rewrites the destination IP address when the data packet is being forwarded to the edge server 170 as shown in 308 and 324 in FIG. 3. The DNAT component 414 rewrites the source IP address (reverse DNAT) when the data packet is forwarded to the edge router 150 as shown in 312, 316, and 320 in FIG. 3. After the DNAT component 414 rewrites the source IP address, the encap/decap component 410 encapsulates the data packet and sets the edge router 150 as the next hop.

The edge server 170 includes a network interface component 416. The network interface component 416 configures the edge server 170 to have one or more network interfaces. The unique internal IP address 130 can be assigned to the network interfaces. For example, the network interfaces are assigned IP addresses in the IP space 169.1.1.0/16. In some embodiments, the network interface component 416 utilizes Multus, a Container Network Interface (CNI) plugin for Kubernetes that enables attaching multiple network interfaces, to enhance the networking capability. Multus can support applications that require multiple interfaces, improving network performance and flexibility. Additionally, Multus enhances network isolation and segmentation by allowing different types of traffic on separate interfaces, reducing the risk of interference. Using the configured network interfaces, the edge server 170 handle the transfer of data.

The data packets are processed by the edge server 170, which can apply caching, web application firewall (WAF), routing, or any other CDN features provided by the edge server 170. This can be done by the driver, or a separate driver, or the edge server. (L7 packets).

The edge server 170 may include Layer 4 (L4) and Layer 7 (L7) servers 418. L4 server handles traffic based on IP addresses and TCP/UDP ports. L7 server operates at the application layer, handling traffic based on application-level data such as HTTP headers, URLs, and cookies.

The edge server 170 includes a cache 430, which contains cached contents and/or data. If a request reaches the edge server 170, the edge server 170 checks the cache 430 for the requested content. If the content is cached, it is served from the edge server 170, reducing the need to fetch it from the origin server (e.g., origin server 188). When the requested content is cached, the edge server 170 retrieves the requested content from the cache 430 and sends it to the driver 172. As described in reference to FIG. 1-3, the DNAT component 414 of the driver 172 performs reverse DNAT to rewrite the source IP, and the encap/decap component 410 of the driver 172 encapsulates the requested content and forwards it to the edge server 170. If the requested content is not cached, it is fetched from the origin server as described above in reference to FIG. 1-3. In some embodiments, the fetched content is stored in the cache 430 to reduce the need to fetch it again for subsequent requests.

The cache 430 works in conjunction with L4/L7 servers 418 to optimize delivery of cached content. For example, L4 checks the cache 430 for the requested content. L7 manages dynamic content caching, ensuring that frequently accessed dynamic content is served quickly from the cache 430.

The edge server 170 provides a web application firewall (WAF) 440, which protects web applications by filtering and monitoring HTTP traffic between a web application and the Internet. WAF 440 monitors and inspects incoming and outgoing HTTP/HTTPS traffic at the edge server 170, looking for malicious patterns and behaviors. The WAF 440 ensures that legitimate traffic is served quickly while malicious traffic is blocked.

In some embodiments, the WAF 440 may define Access Control Lists (ACLs) to control access to the resources in the edge server 170 based on IP addresses, geolocation, and/or other criteria.

The edge server 170 includes other CDN applications 450 including, but not limited to, routing, API gateway, traffic management, and edge computing. CDN can provide functionalities such as data security, data encryption, edge computing, authentication, etc.

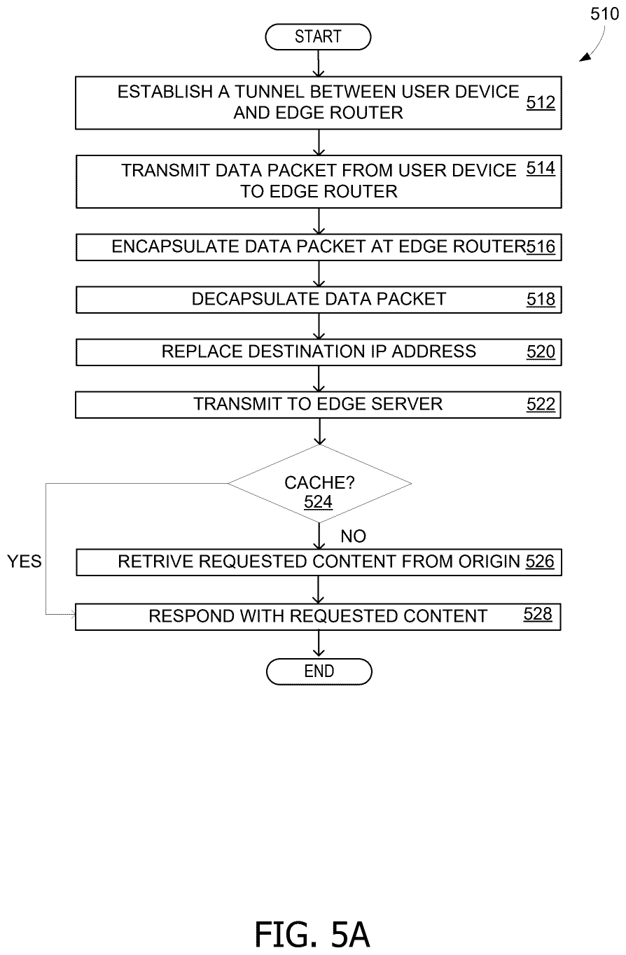

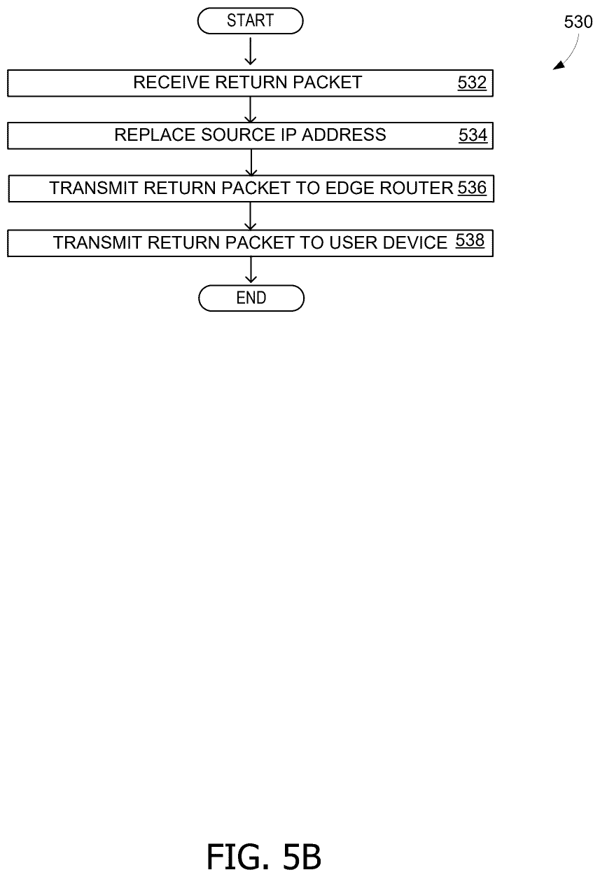

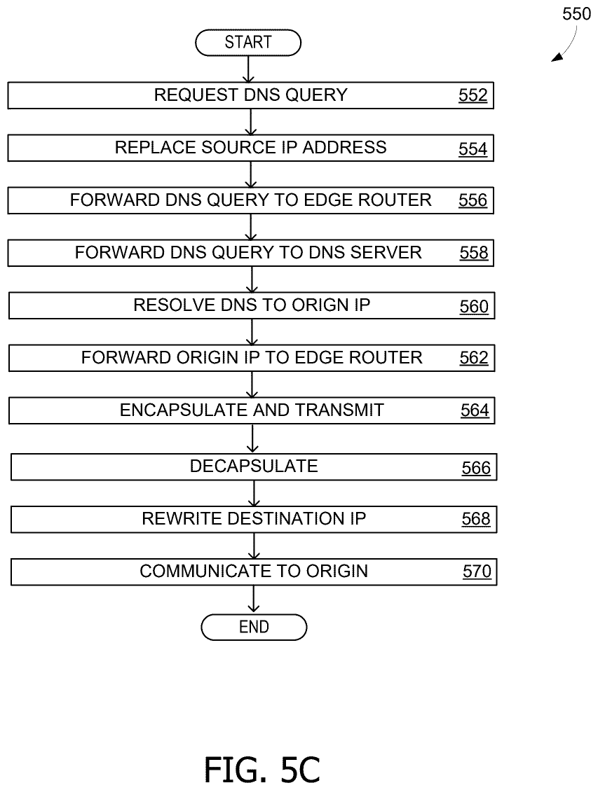

FIGS. 5A-5C are flowcharts illustrating certain processes of providing private CDN connection in accordance with embodiments of the disclosure. Even though embodiments of the processes are described below with reference to the computing framework 100 of FIG. 1, in other embodiments, the processes can be implemented in computing frameworks with additional and/or different components.

As shown in FIG. 5A, a process 510 starts with a provisioning process a private connection from a user device to an edge server at 512. The provisioning process includes generating a private profile for a tenant. The user device is associated with the tenant, as an employee, student, contractor, client, or a user. The tenant network administrator provides a VNET ID and the private subnet IP address space as described above. A unique internal IP address is generated for the tenant. During the provisioning process, a tunnel between the user device on premises (e.g., user device 104) and an edge router (e.g., edge router 150) is established. In some embodiments, the tunnel between the user device and the edge router is a MPLS tunnel. The user device transmits data packet, which includes a content request from the user to the edge router at 514. The content request from the user device has the user's IP address in the source IP address field, and the subnet IP address in the destination IP address field. At 516, the edge router encapsulates the data packet to add the tenant's VNI (e.g., VNI 128) in the outer header of the data packet. The edge router sets up a tunnel between the edge router and the edge server and transmits the encapsulated data packet. In some embodiments, the tunnel between the edge router and the edge server is a VxLan tunnel, and the edge router performs a VxLan encapsulation of the data packet.

At 518, the driver (e.g., driver 172) connected to the edge server receives the data packet. The driver can be, but not limited to, an in-line router, a dedicated router on a different node, or a driver included in the edge server. In some embodiments, the driver is an eBPF. The driver decapsulates the data packet and retrieves the VNI. At 520, the driver rewrites the inner packet, replacing the destination IP address field with the internal tenant-specific IP address. At 522, the driver transmits the data packet to the edge server. At 524, the edge server checks its cache to determine whether the data packet can be processed. If the cache misses, the edge server communicates with the origin server and retrieves the requested content from the origin server at 526. The process of the edge server communicating with the origin server via private connection is described in more detail with reference to FIG. 5C.

If the cache contains the requested content, the edge server provides the requested content at 528. The process of returning the requested content is described in more detail with reference to FIG. 5B.

FIG. 5B illustrates a process 530 of returning data packets from the edge server to the user device. At 532, the driver receives returning data packets transmitted from the edge server. At 534, the driver modifies the source IP address field, replacing it with the subnet IP address. At 536, the driver encapsulates the return packet and sends it to the edge router. At 538, the edge router forwards the return packet to the user device.

FIG. 5C illustrates a process 550 of sending DNS query to the private DNS server through the private connection. At 552, the edge server sends a DNS query request for the domain name for the origin. At 554, the driver receives the DNS query request and modifies the source IP address with the subnet IP address. The driver forwards the request to the edge router at 556. At 558, the edge router forwards the request to the private DNS resolver (e.g., private DNS server 186) in the user's VNET (e.g., VNET 180). At 560, the private DNS server resolves the domain name to the IP address of the origin server. The packet including the origin IP address is forwarded to the edge router at 562. The edge router encapsulates the packet with the user's VNI and sends it to the driver at 564. The driver decapsulates the packet to retrieve the VNI at 566. The driver rewrites the destination IP address field, replacing the subnet IP address with the internal unique IP address at 568. The packet with the origin IP address reaches the edge server and the edge server communicates with the origin server at 570.

### Additional Examples

An example computer-implemented method for providing a private content delivery network (CDN) connection, the method comprises: receiving, by a driver, a data packet, from an edge router, the data packet encapsulated with a tenant specific Virtual Network Identifier (VNI), the data packet comprising a user IP address in a source IP field and a subnet IP address in a destination IP field; decapsulating, by the driver, the data packet to retrieve the tenant specific VNI; replacing, by the driver, the destination IP field of the data packet with an internal IP address; transmitting, by the driver, the data packet to an edge server, wherein the data packet is processed by the edge server; receiving, by the driver, a returning data packet from the edge server, the returning data packet comprising the internal IP address in the source IP field and the user IP address in the destination IP field; replacing, by the driver, the source IP field of the returning data packet with the subnet IP address; and transmitting, by the driver, the returning data packet to the edge router.

An example system for providing a private connection to content delivery network (CDN) comprises: A system for providing a private connection to content delivery network (CDN), the system comprising: an edge router configured to: receive a data packet from a user device via a data flow established between the edge router and the user device, the data packet comprising a user IP address in a source IP field and a subnet IP address in a destination IP field; encapsulate the data packet with a tenant specific virtual network identifier (VNI); establish a data tunnel to an edge server, and transmit the data packet to the edge server; and a driver connected to the edge server, the driver configured to: receive the data packet from the edge router; decapsulate the data packet to retrieve the tenant specific VNI; replace the destination IP field of the data packet with an internal IP address; transmit the data packet to the edge server, wherein the edge server processes the data packet;
receive a returning data packet from the edge server, the returning data packet comprising the internal IP address in the source IP field and the user IP address in the destination IP field;

One or more computer-readable storage media encoding has computer-executable instructions encoding a computer process comprises: receiving, by a driver, a data packet, from an edge router, the data packet encapsulated with a tenant specific Virtual Network Identifier (VNI), the data packet comprising a user IP address in a source IP field and a subnet IP address in a destination IP field; decapsulating, by the driver, the data packet to retrieve the tenant specific VNI; replacing, by the driver, the destination IP field of the data packet with an internal IP address; transmitting, by the driver, the data packet to an edge server, wherein the data packet is processed by the edge server; receiving, by the driver, a returning data packet from the edge server, the returning data packet comprising the internal IP address in the source IP field and the user IP address in the destination IP field; replacing, by the driver, the source IP field of the returning data packet with the subnet IP address; and transmitting, by the driver, the returning data packet to the edge router.

Alternatively, or in addition to the other examples described herein, examples include any combination of the following:
wherein a data flow between a user device and the edge router is established by a MPLS tunnel;
wherein the data tunnel is VxLan tunnel, and the edge router performs a VxLan encapsulation of the data packet;
wherein the edge router determines the tenant specific VNI based on the subnet IP address;
wherein the internal IP address is mapped to the tenant specific VNI;
wherein the driver is an extended Berkley Packet Filter (eBPF).
wherein the driver is included in the edge server;
wherein the driver is further configured to: receiving a domain name system (DNS) request from the edge server based on the edge server processing of the data packet is unsuccessful; replace the source IP address of the DNS query with the user IP address; transmit the DNS query to the edge router, wherein the edge router forwards the DNS query to a private DNS resolver.

While the aspects of the disclosure have been described in terms of various examples with their associated operations, a person skilled in the art would appreciate that a combination of operations from any number of different examples is also within scope of the aspects of the disclosure.

### Example Operating Environment

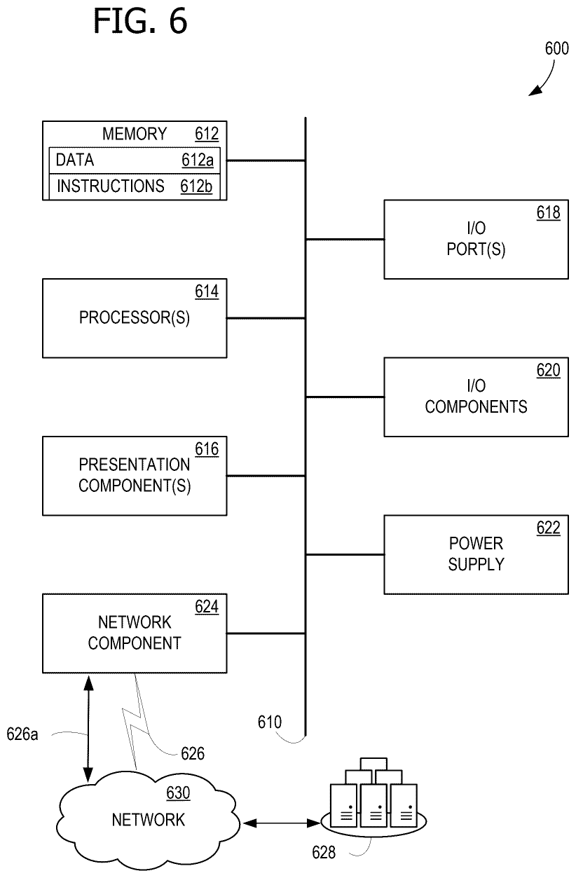

FIG. 6 is a block diagram of an example computing device 600 (e.g., a computer storage device) for implementing aspects disclosed herein, and is designated generally as computing device 600. In some examples, one or more computing devices 600 are provided for an on-premises computing solution. In some examples, one or more computing devices 600 are provided as a cloud computing solution. In some examples, a combination of on-premises and cloud computing solutions are used. Computing device 600 is but one example of a suitable computing environment and is not intended to suggest any limitation as to the scope of use or functionality of the examples disclosed herein, whether used singly or as part of a larger set.

Neither should computing device 600 be interpreted as having any dependency or requirement relating to any one or combination of components/modules illustrated. The examples disclosed herein may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. The disclosed examples may be practiced in a variety of system configurations, including personal computers, laptops, smart phones, mobile tablets, hand-held devices, consumer electronics, specialty computing devices, etc. The disclosed examples may also be practiced in distributed computing environments when tasks are performed by remote-processing devices that are linked through a communications network.

Computing device 600 includes a bus 610 that directly or indirectly couples the following devices: computer storage memory 612, one or more processors 614, one or more presentation components 616, input/output (I/O) ports 618, I/O components 620, a power supply 622, and a network component 624. While computing device 600 is depicted as a seemingly single device, multiple computing devices 600 may work together and share the depicted device resources. For example, memory 612 may be distributed across multiple devices, and processor(s) 614 may be housed with different devices.

Bus 610 represents what may be one or more buses (such as an address bus, data bus, or a combination thereof). Although the various blocks of FIG. 6 are shown with lines for the sake of clarity, delineating various components may be accomplished with alternative representations. For example, a presentation component such as a display device is an I/O component in some examples, and some examples of processors have their own memory. Distinction is not made between such categories as “workstation,” “server,” “laptop,” “hand-held device,” etc., as all are contemplated within the scope of FIG. 6 and the references herein to a “computing device.” Memory 612 may take the form of the computer storage media referenced below and operatively provide storage of computer-readable instructions, data structures, program modules and other data for the computing device 600. In some examples, memory 612 stores one or more of an operating system, a universal application platform, or other program modules and program data. Memory 612 is thus able to store and access data 612a and instructions 612b that are executable by processor 614 and configured to carry out the various operations disclosed herein. Thus, computing device 600 comprises a computer storage device having computer-executable instructions 612b stored thereon.

In some examples, memory 612 includes computer storage media. Memory 612 may include any quantity of memory associated with or accessible by the computing device 600. Memory 612 may be internal to the computing device 600 (as shown in FIG. 6), external to the computing device 600 (not shown), or both (not shown). Additionally, or alternatively, the memory 612 may be distributed across multiple computing devices 600, for example, in a virtualized environment in which instruction processing is carried out on multiple computing devices 600. For the purposes of this disclosure, “computer storage media,” “computer storage memory,” “memory,” and “memory devices” are synonymous terms for the memory 612, and none of these terms include carrier waves or propagating signaling.

Processor(s) 614 may include any quantity of processing units that read data from various entities, such as memory 612 or I/O components 620. Specifically, processor(s) 614 are programmed to execute computer-executable instructions for implementing aspects of the disclosure. The instructions may be performed by the processor, by multiple processors within the computing device 600, or by a processor external to the client computing device 600. In some examples, the processor(s) 614 are programmed to execute instructions such as those illustrated in the flow charts discussed below and depicted in the accompanying drawings. Moreover, in some examples, the processor(s) 614 represents an implementation of analog techniques to perform the operations described herein. For example, the operations may be performed by an analog client computing device 600 and/or a digital client computing device 600. Presentation component(s) 616 present data indications to a user or other device. Exemplary presentation components include a display device, speaker, printing component, vibrating component, etc.

One skilled in the art will understand and appreciate that computer data may be presented in a number of ways, such as visually in a graphical user interface (GUI), audibly through speakers, wirelessly between computing devices 600, across a wired connection, or in other ways. I/O ports 618 allow computing device 600 to be logically coupled to other devices including I/O components 620, some of which may be built in. Example I/O components 620 include, for example but without limitation, a microphone, joystick, game pad, satellite dish, scanner, printer, wireless device, etc.

Computing device 600 may operate in a networked environment via the network component 624 using logical connections to one or more remote computers. In some examples, the network component 624 includes a network interface card and/or computer-executable instructions (e.g., a driver) for operating the network interface card. Communication between the computing device 600 and other devices may occur using any protocol or mechanism over any wired or wireless connection. In some examples, network component 624 is operable to communicate data over public, private, or hybrid (public and private) using a transfer protocol, between devices wirelessly using short range communication technologies (e.g., near-field communication (NFC), Bluetooth™ branded communications, or the like), or a combination thereof. Network component 624 communicates over wireless communication link 626 and/or a wired communication link 626a to a remote resource 628 (e.g., a cloud resource) across a computer network 630. Various different examples of communication links 626 and 626a include a wireless connection, a wired connection, and/or a dedicated link, and in some examples, at least a portion is routed through the internet.

Although described in connection with an example computing device 600, examples of the disclosure are capable of implementation with numerous other general-purpose or special-purpose computing system environments, configurations, or devices. Examples of well-known computing systems, environments, and/or configurations that may be suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, virtual reality (VR) devices, augmented reality (AR) devices, mixed reality devices, holographic device, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. Computer storage media for purposes of this disclosure are not transitory. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. In contrast, communication media typically embody computer readable instructions, data structures, program modules, or the like in a modulated data signal such as a carrier wave or other transport mechanism and include any information delivery media.

The order of execution or performance of the operations in examples of the disclosure illustrated and described herein is not essential, and may be performed in different sequential manners in various examples. For example, it is contemplated that executing or performing a particular operation before, contemporaneously with, or after another operation is within the scope of aspects of the disclosure. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A method for providing a private content delivery network (CDN) connection, the method comprising:
receiving, by a driver, a data packet, from an edge router, the data packet encapsulated with a tenant specific Virtual Network Identifier (VNI), the data packet comprising a user IP address in a source IP field and a subnet IP address in a destination IP field;
decapsulating, by the driver, the data packet to retrieve the tenant specific VNI;
replacing, by the driver, the destination IP field of the data packet with an internal IP address;
transmitting, by the driver, the data packet to an edge server, wherein the data packet is processed by the edge server;
receiving, by the driver, a returning data packet from the edge server, the returning data packet comprising the internal IP address in the source IP field and the user IP address in the destination IP field;
replacing, by the driver, the source IP field of the returning data packet with the subnet IP address; and
transmitting, by the driver, the returning data packet to the edge router.

2. The method of claim 1, wherein the data packet is transmitted from a user device to the edge router via a data flow established between the edge router and the user device.

3. The method of claim 2, wherein the data flow is a MPLS tunnel.

4. The method of claim 1, wherein the driver is an extended Berkley Packet Filter (be).

5. The method of claim 1, wherein the data packet is transmitted from the edge router to the driver via a data tunnel, and wherein the edge router performs an encapsulation to the data packet, the encapsulation comprising adding the tenant specific VNI to the data packet, before transmitting the data packet.

6. The method of claim 5, wherein the data tunnel is a Virtual Extensible Lan (VxLAN) tunnel, and the edge router performs a VxLan encapsulation of the data packet.

7. The method of claim 1, further comprising:
receiving, by the driver, a domain name system (DNS) query from the edge server based on the edge server processing of the data packet is unsuccessful;
replacing, by the driver, the source IP field of the DNS query with the internal IP address; and
transmitting, by the driver, the DNS query to the edge router, wherein the DNS query is forwarded to a private DNS resolver.

8. The method of claim 7, further comprising:
receiving, by the driver, a content request from the edge server;
replacing, by the driver, the source IP field of the content request with the internal IP address; and
transmitting, by the driver, the content request to the edge router, wherein the content request is forwarded to an origin server.

9. A system for providing a private connection to content delivery network (CDN), the system comprising:
an edge router configured to:
receive a data packet from a user device via a data flow established between the edge router and the user device, the data packet comprising a user IP address in a source IP field and a subnet IP address in a destination IP field;
encapsulate the data packet with a tenant specific virtual network identifier (VNI);
establish a data tunnel to an edge server, and
transmit the data packet to the edge server; and
a driver connected to the edge server, the driver configured to:
receive the data packet from the edge router;
decapsulate the data packet to retrieve the tenant specific VNI;
replace the destination IP field of the data packet with an internal IP address;
transmit the data packet to the edge server, wherein the edge server processes the data packet;
receive a returning data packet from the edge server, the returning data packet comprising the internal IP address in the source IP field and the user IP address in the destination IP field;
replace the source IP field with the subnet IP address; and
transmit the returning data packet to the edge router.

10. The system of claim 9, wherein the data flow is established by MPLS tunnel.

11. The system of claim 9, wherein the data tunnel is a Virtual Extensible Lan (VxLan) tunnel, and wherein the edge router performs a VxLan encapsulation of the data packet.

12. The system of claim 9, wherein the driver is an extended Berkley Packet Filter (eBPF).

13. The system of claim 9, wherein the driver is further configured to:
receive a domain name system (DNS) query from the edge server based on the edge server processing of the data packet is unsuccessful;
replace the source IP field of the DNS query with the internal IP address; and
transmit the DNS query to the edge router, wherein the DNS query is forwarded to a private DNS resolver.

14. The system of claim 13, further comprising:
receiving, by the driver, a content request from the edge server;
replacing, by the driver, the source IP field of the content request with the internal IP address;
and
transmitting, by the driver, the content request to the edge router, wherein the content request is forwarded to an origin server.

15. One or more computer-readable storage media encoding computer-executable instructions encoding a computer process comprising:
receiving, by a driver, a data packet, from an edge router, the data packet encapsulated with a tenant specific Virtual Network Identifier (VNI), the data packet comprising a user IP address in a source IP field and a subnet IP address in a destination IP field;
decapsulating, by the driver, the data packet to retrieve the tenant specific VNI;
replacing, by the driver, the destination IP field of the data packet with an internal IP address;
transmitting, by the driver, the data packet to an edge server, wherein the data packet is processed by the edge server;
receiving, by the driver, a returning data packet from the edge server, the returning data packet comprising the internal IP address in the source IP field and the user IP address in the destination IP field;
replacing, by the driver, the source IP field of the returning data packet with the subnet IP address; and
transmitting, by the driver, the returning data packet to the edge router.

16. The one or more computer-readable storage media of claim 15, wherein the data packet is transmitted from a user device to the edge router via a data flow established between the edge router and the user device, and wherein the data flow is a MPLS tunnel.

17. The one or more computer-readable storage media of claim 15, wherein the driver is an extended Berkley Packet Filter (eBPF).

18. The one or more computer-readable storage media of claim 15, wherein the data packet is transmitted from the edge router to the driver via a Virtual Extensible Lan (VxLan) data tunnel, and wherein the edge router performs a VxLan encapsulation to the data packet, the VxLan encapsulation comprising adding the tenant specific VNI to the data packet, before transmitting the data packet.

19. The one or more computer-readable storage media of claim 15, wherein the computer-executable instructions further comprising:
receiving, by the driver, a domain name system (DNS) query from the edge server based on the edge server processing of the data packet is unsuccessful;
replacing, by the driver, the source IP field of the DNS query with the internal IP address; and
transmitting, by the driver, the DNS query to the edge router, wherein the DNS query is forwarded to a private DNS resolver.

20. The one or more computer-readable storage media of claim 19, wherein the computer-executable instructions further comprising:
receiving, by the driver, a content request from the edge server;
replacing, by the driver, the source IP field of the content request with the internal IP address; and
transmitting, by the driver, the content request to the edge router, wherein the content request is forwarded to an origin server.
